(19) United States
(12) Patent Application Publication
(10) Pub. No.: US 2013/0259516 A1
(43) Pub. Date: Oct. 3, 2013

(54) IMAGE FORMING APPARATUS WITH PROCESS CARTRIDGE CAPABLE OF MINIMIZING DAMAGE TO A WRITING DEVICE

(71) Applicants: Tamotsu IKEDA, Osaka (JP); Kuniyori TAKANO, Kanagawa (JP)

(72) Inventors: Tamotsu IKEDA, Osaka (JP); Kuniyori TAKANO, Kanagawa (JP)

(73) Assignee: Ricoh Company, Ltd., Tokyo (JP)

(21) Appl. No.: 13/779,955

(22) Filed: Feb. 28, 2013

(30) Foreign Application Priority Data
Mar. 30, 2012 (JP) 2012-079079
Oct. 12, 2012 (JP) 2012-226917

(51) Int. Cl. G03G 15/00; G03G 21/18

(52) U.S. Cl. CPC G03G 15/22
USPC 399/110; 399/111

(57) ABSTRACT

An image forming apparatus includes a detachable latent image bearer, a casing including a cover opened and closed when the latent image bearer is detached and attached thereto, an LED array head opposed to the latent image bearer, and a rotation mechanism to rotate the LED array head in synchrony with either insertion and removal operation of the latent image bearer or opening operation of the cover.

### CROSS-REFERENCE TO RELATED APPLICATIONS

This patent application is based on and claims priority pursuant to 35 U.S.C. §119 to Japanese Patent Application Nos. 2012-079079 and 2012-226917, filed on Mar. 30, 2012 and Oct. 12, 2012, respectively, in the Japan Patent Office, the entire disclosures of which are hereby incorporated by reference herein.

### BACKGROUND

1. Field

The present invention relates to an image forming apparatus, such as a copier, a printer, a printing press, etc., and more particularly to an evacuation structure to evacuate a writing device from a detachable image formation unit included in the image forming apparatus.

2. Related Art

As is well known, an electrostatic latent image formed on a photoconductor of an image forming apparatus as a latent image bearer is processed into a visible image by developer supplied from a developing device. The toner image is then transferred onto a transfer sheet and is fixed thereon by a fixing device applying heat and pressure.

Certain image forming apparatuses are configured to form multiple color images, such as a full-color image, etc., in addition to monochrome images. To form a multiple color image, different component color images are initially formed in multiple image forming units and are sequentially transferred onto an intermediate transfer member, such as a belt, etc., (i.e., a primary transfer process), and the thus-superimposed images are transferred from the intermediate transfer member onto a recording medium, such as a recording sheet, etc., at once (i.e., a secondary transfer process).

Further, to form an electrostatic latent image, a system of irradiating a photoconductor with a writing beam in accordance with image information is frequently employed. As one example of such a system, an LED array head is conventionally used to expose the surface of the photoconductor. The LED array head is positioned relative to the photoconductor in an image formation unit. As an exemplary configuration of the image formation unit, a process cartridge integrally accommodating a charger, the photoconductor, a developing device, and a cleaner or the like, is sometimes employed in the image formation processing.

The process cartridge is sometimes detachably attached to the image forming apparatus to expose a recording medium conveyance path and remove a jammed sheet or replace applicable parts. Specifically, a configuration detaching the process cartridge from the image forming apparatus to an outside thereof is known. In a system using the above-described process cartridge, the LED array head may sometimes evacuate from a write position facing the photoconductor when the process cartridge is withdrawn. The reason to adopt such a system is to avoid damage to the surface of the photoconductor possibly caused when the photoconductor moves and contacts the LED array head on condition that positioning of the photoconductor and the LED array head is fixed.

As an exemplary system to evacuate the LED array head from the photoconductor, a system is known (for example, Japan Patent Application Publication No. 2004-167728 (JP-2004-167728-A)) in which the LED array head is disposed on an inner surface of a cover arranged on a top of an apparatus, and the LED array head is caused to evacuate from a position opposed to the photoconductor when the cover is opened. Further, another system is also proposed as described in Japan Patent Application Publication Nos. 2001-175046 (JP-2001-175046-A) and 2007-140392 (JP-2007-140392-A), in which either an elevating guide is disposed at a portion of the process cartridge to move the LED array head vertically, or a driving mechanism is provided to link with operation of detaching and attaching the process cartridge for insertion and removal thereof instead of using the above-described opening and closing. Consequently, the LED array head can be moved vertically in conjunction with the insertion and removal operation of the process cartridge to cause the LED array head to evacuate from a position opposed to the photoconductor.

In the system as disclosed in JP-2004-167728-A, when the cover is opened, the LED array head is left exposed outside. Accordingly, a user may touch the LED array carelessly. As a result, the LED is likely corrupted or polluted, thereby degrading writing performance.

Further, the systems disclosed in JP-2001-175046-A and JP-2007-140392-A do not require a space around the image forming apparatus. However, space is required within the apparatus to separate the LED array head. Thus, the image forming apparatus itself likely becomes upsized.

### SUMMARY

Accordingly, the present invention provides a novel image forming apparatus that includes a detachable latent image bearer, a casing including a cover opened and closed when the latent image bearer is detached and attached thereto, an LED array head opposed to the latent image bearer, and a rotation mechanism to rotate the LED array head in synchrony with either insertion and removal operation of the latent image bearer or opening operation of the cover.

In another aspect of the present invention, the latent image bearer is housed in a process cartridge along with an image forming device.

In yet another aspect of the present invention, the LED array head is rotated when the cover is opened and the process cartridge is withdrawn outside the apparatus from a position opposed to the latent image bearer.

In yet another aspect of the present invention, the LED array head includes a rocking arm biased in a direction in which the process cartridge is withdrawn outside. The process cartridge includes a cam side to engage and stop swinging of the rocking arm against bias. The rocking arm is allowed to swing along the cam side in a direction in which the process cartridge is withdrawn outside in synchrony with withdrawing operation of the process cartridge to evacuate the LED array head from the latent image bearer.

In yet another aspect of the present invention, the rocking arm of the LED array head includes an engaged section protruding toward the process cartridge from its free end when located at an evacuated position from the latent image bearer. The engaging section is depressed by the process cartridge when the process cartridge is inserted and located at a prescribed insertion position.

In yet another aspect of the present invention, the process cartridge includes a guide to locate the LED array head at a prescribed position opposed to the latent image bearer when the process cartridge is inserted into the apparatus.

In yet another aspect of the present invention, a link lever linked with the cover of the apparatus is provided to cooperate with opening and closing of the cover, the link lever including a cam facing the LED array head. The LED array head is enabled to either contact or separate from the latent image bearer in accordance with movement of the link lever.

In yet another aspect of the present invention, the LED array head includes a swingable lifter swingable in a direction in which the process cartridge containing the latent image bearer is withdrawn. The rotatable lifter includes a roller contacting the cam side formed on the process cartridge.

In yet another aspect of the present invention, a first shock absorber is arranged to absorb shock when contacted by the LED array head rotating and evacuating from the latent image bearer.

In yet another aspect of the present invention, a second shock absorber is arranged between the swingable lifter and the LED array head.

### BRIEF DESCRIPTION OF THE DRAWINGS

A more complete appreciation of the present invention and many of the attendant advantages thereof will be more readily obtained as substantially the same becomes better understood by reference to the following detailed description when considered in connection with the accompanying drawings, wherein:

FIG. 1 is a schematic diagram illustrating a fundamental configuration of an image forming apparatus according to one embodiment of the present invention;

FIG. 2 is a schematic diagram illustrating a problem caused in the image forming apparatus shown in FIG. 1;

FIG. 3 is a schematic diagram illustrating an exemplary configuration of the image forming apparatus according to one embodiment of the present invention;

FIG. 4 is a schematic diagram illustrating exemplary operation executed by the image forming apparatus with the configuration as shown in FIG. 3;

FIGS. 5A and 5B are schematic diagrams collectively illustrating an essential configuration of the image forming apparatus shown in FIG. 3 according to one embodiment of the present invention;

FIG. 6 is a diagram illustrating a positioning structure provided in the essential configuration shown in FIG. 5;

FIGS. 7A, 7B, and 7C are schematic diagrams collectively illustrating an essential configuration of the image forming apparatus according to another embodiment of the present invention; and

FIGS. 8A and 8B are schematic diagrams collectively illustrating an essential part of a modification according to yet another embodiment of the present invention.

### DETAILED DESCRIPTION

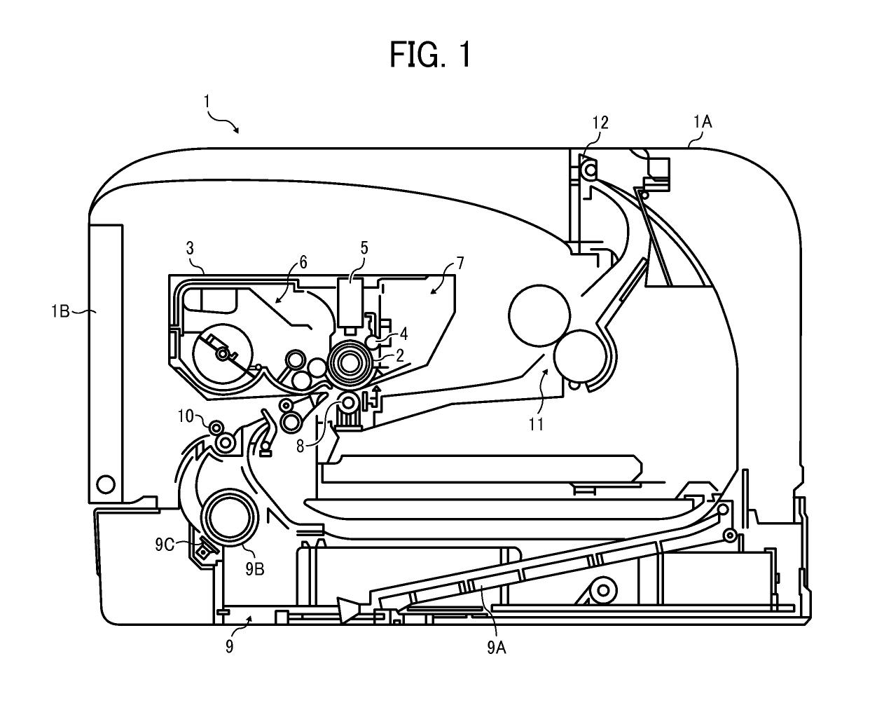

Referring now to the drawings, wherein like reference numerals designate identical or corresponding parts throughout the several views thereof and in particular to FIG. 1, an image forming apparatus with a configuration based by this invention is described. In this drawing, a single photoconductor 2 used as a latent image bearer is included in the image forming apparatus 1 to form a black and white image. The photoconductor 2 is arranged in a process cartridge 3 to be used in forming an image, and the process cartridge 3 is detachably attached to an apparatus 1A mainly consisting of a casing.

Since the process cartridge 3 constitutes the image formation unit, a charger 4, a writing unit 5, a developing device 6, and a cleaner 7 to clean the photoconductor as a cleaning target in a post-transfer process, each needed in image formation processing, are collectively accommodated around the photoconductor 2 therein.

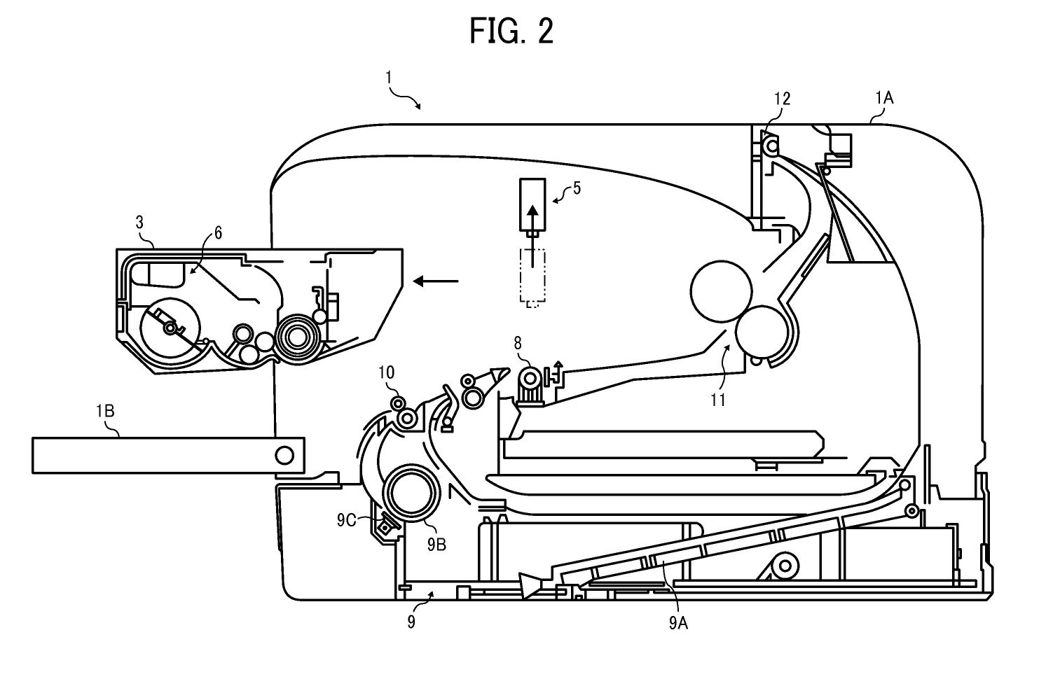

The writing unit 5 is provided to vertically move vertically in the apparatus 1A at a location other than the process cartridge 3. Specifically, the writing unit 5 performs write operation when it is opposed to the photoconductor 2 as shown in FIG. 1. Further, the writing unit 5 moves up separating from the photoconductor 2 in the apparatus 1A when the process cartridge 3 is withdrawn from the apparatus 1 as shown in FIG. 2.

Further, a transfer roller 8 is disposed in the image forming apparatus 1 at a position opposed to the photoconductor 2 arranged in the process cartridge 3. A recording sheet launched from the sheet feeding device 9 placed at a lower side in the image forming apparatus 1 is conveyed to the transfer roller 8 at registration timing determined by the registration roller 10. When the sheet reaches a position of the transfer roller 8, a transfer process is executed.

The sheet feeding device 9 includes a sheet feeding cassette 9a filled with recording sheets, a sheet feeding roller 9b to launch sheets from the sheet cassette 9a, and a friction pad 9c to separate the sheets one by one. The recording sheet completing the transfer process is conveyed to a fixing unit 11 and is subjected to fixing of an image and is ejected by a sheet ejection roller 12 onto a sheet ejection tray,

The process cartridge 3 is withdrawn to an outside of the apparatus 1A during recovery from jamming of a sheet in a conveyance path located near the process cartridge 3 and execution of replacement or maintenance of parts equipped therein. To bring the process cartridge 3 outside the apparatus 1A, an opening for allowing installation and extraction of the process cartridge 3 and a cover 1B for opening and closing the opening are provided in the apparatus 1.

In the above-described configuration, the writing unit 5 needs to be spaced from the photoconductor 2 when installing and removing the process cartridge 3 to avoid damage to the photoconductor 2 cause by contact therewith. Thus, a prescribed space is needed for the writing unit 5 to move vertically as shown in the drawing. With such vertical movement, the space needed in the apparatus 1 increases as does a height thereof thereby enlarging the system.

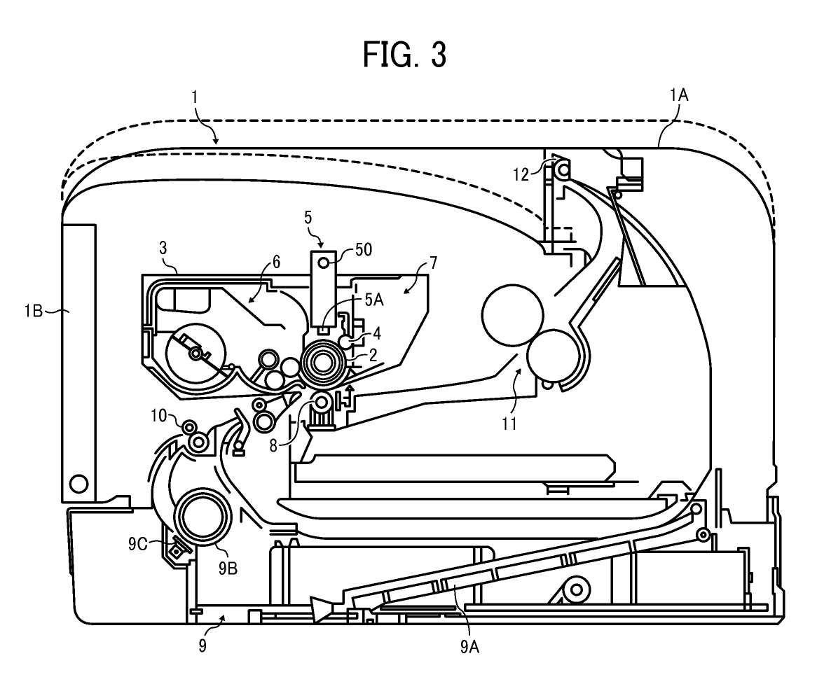

In this embodiment, as a system to evacuate the writing unit 5 from the photoconductor 2, a rotation mechanism capable of rotating the writing unit 5 in synchrony with the insertion and removal of the process cartridge 3 is adopted rather than elevating the same as shown in FIG. 3. As a result, as shown by broken lines in FIG. 3, such a rotating mechanism decreases the height of the conventional apparatus, specifically downsizes in the vertical direction.

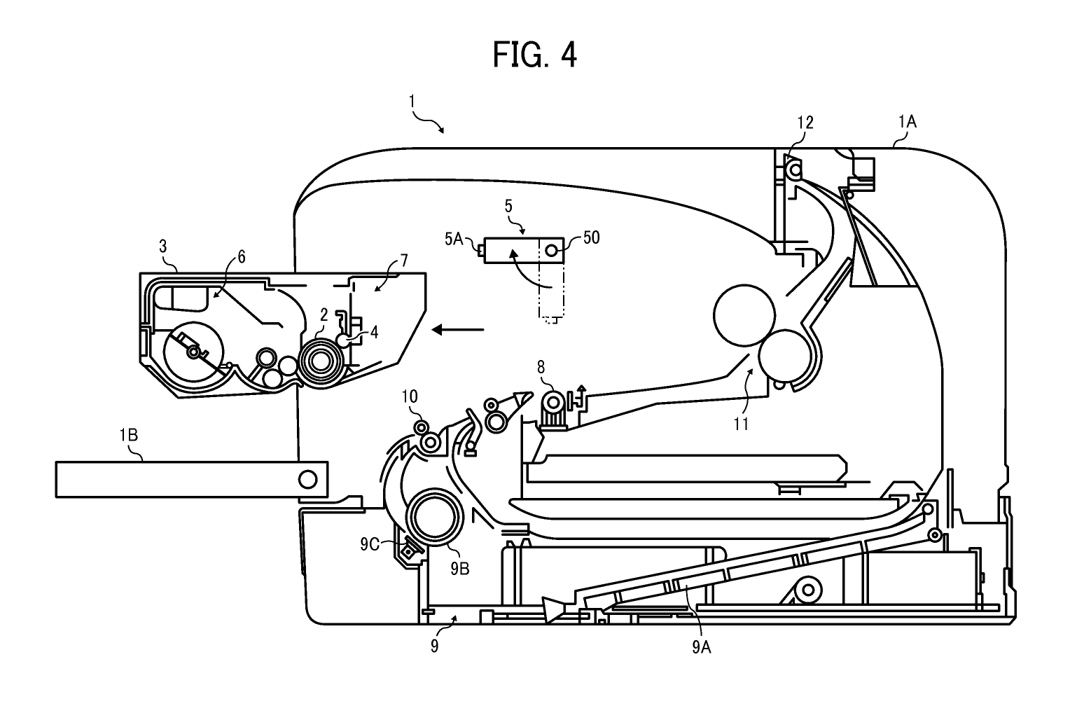

FIG. 3 is a diagram that shows an aspect when the process cartridge 3 shown in FIG. 1 is inserted into the apparatus 1A. In this situation, the writing unit 5 faces the photoconductor 2 as shown. As the writing unit 5, an LED (Light Emitting Device) array head 5A constituted by arranging multiple LEDs in a main scanning direction of the photoconductor 2 is used. The writing unit 5 rotates around a rotation supporting shaft as a fulcrum above a moving path (i.e., a position shown by arrow) for insertion and removal of the process cartridge 3 in FIG. 4 as indicated by a reference code 50 in synchrony with insertion and removal operation of the process cartridge 3. An aspect when the process cartridge 3 is withdrawn is shown in FIG. 4. As shown in FIG. 4, the writing unit 5 can rotate in the direction (i.e., clockwise in FIG. 4) in which the process cartridge 3 is pulled out successively after the cover 1B is opened.

In a situation as shown in FIG. 4, when a chip of the writing unit 5 rotates around the fulcrum of its own in a direction parting from the photoconductor 2, the LED array head 5A is caused to evacuate from a position at which a user likely inadvertently touches the head 5A without impeding withdrawing of the process cartridge 3 therefrom. Hence, if a space exists corresponding to a turning radius of the writing unit 5 inside the apparatus, the LED array head 5A can be evacuated from the position at which the user likely inadvertently touches the head 5A without impeding withdrawing of the process cartridge 3. When the LED array head 5A rotates in the direction to evacuate from the photoconductor 2, a space occupied by the process cartridge 3 becomes accessible. Thus, operation, such as cleaning, etc., may be performed from the outside while preventing a user from carelessly touching the LED array head 5A during the operation.

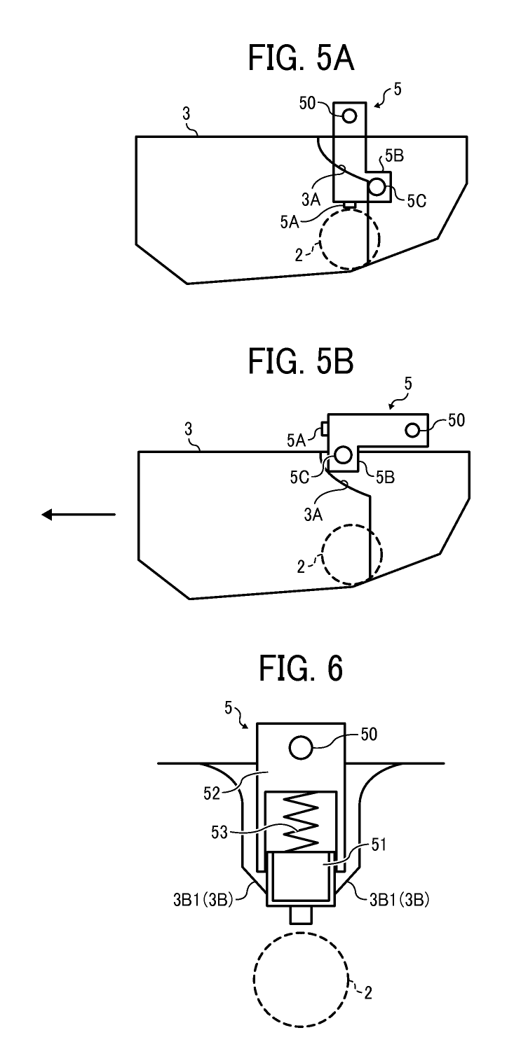

An exemplary rotary mechanism for rotating the above-described writing unit 5 is illustrated in FIGS. 5A and 5B. Specifically, the writing unit 5 is enabled to swing clockwise around the supporting shaft 50 as a fulcrum as shown in FIG. 4 in synchrony with withdrawing operation of the process cartridge 3. There is provided an engaging section 5B on a portion of a housing of the writing unit 5 to protrude along a direction in which the process cartridge 3 is detached and attached when the process cartridge 3 is installed in the apparatus. A body of the writing unit 5 swingable around the supporting shaft 50 as a fulcrum is used as a rocking arm.

Further, a cam side 3A is provided at an edge of the process cartridge 3, which is opposed to the engaging pin 5C attached to the writing unit 5, as shown in FIG. 5A. The cam side 3A can face the engaging pin 5C of the writing unit 5 when the process cartridge 3 is inserted into the apparatus 1. Accordingly, when the process cartridge 3 is inserted, and the engaging pin 5C is depressed by the cam side 3A, the writing unit 5 rotates counter clockwise from a state as shown in FIG. 4A, i.e., in a direction in which the process cartridge 3 is inserted and the tip thereof faces the photoconductor 2. The state in which the tip of the writing unit 5 faces the photoconductor 2 is maintained by an engagement section (not shown) engaging therewith when the process cartridge 3 has been inserted.

Hence, with the above-described system, the writing unit 5 with the LED array head can rotate in synchrony with insertion and removal operation of the process cartridge 3. In particular, when the process cartridge 3 is withdrawn outside of the apparatus 1A, the writing unit 5 rotates in the direction in which the process cartridge 3 is withdrawn outside in synchrony with the operation of withdrawing the process cartridge 3 as shown in FIG. 5B. Thus, the writing unit 5 evacuates from the photoconductor 2. Further, in this embodiment, to smoothly evacuate the writing unit 5 from the photoconductor 2, the cam side 3C has a prescribed shape enabling the writing unit 5C to rotate without interference of the engaging pin 5C thereof.

When the process cartridge 3 is inserted into the apparatus 1A, the engaging pin 5C provided in the engaging section 5B of the writing unit 5 is moved by the cam side 3A of the process cartridge 3. Hence, when positioning of it is completed by this, the process cartridge 3 faces the photoconductor 2.

Further, positioning of the writing unit 5 relative to the photoconductor 2 is executed by a configuration as shown in FIG. 6 when the process cartridge 3 is inserted into the apparatus 1A. Specifically, FIG. 6 is a schematic diagram illustrating an interior of the writing device 5. As shown in the drawing, a head 51 constituted by assembling the LED array is provided in the writing unit 5 at a tip thereof as a free end, which is opposed to a base end in which the supporting shaft 50 is located. The head 51 fits into a holder attached to the supporting shaft 50 and is slidably supported therein. An elastic member 53 is placed between the holder 52 and the head 51. Therefore, the head 51 can move toward the photoconductor 2. Whereas, in the process cartridge 3, a guide section 3B is provided to position the writing unit 5. In the guide section 3B, there is provided a positioning surface 3B1. The positioning surface 3B1 positions the head 51 of the writing unit 5 relative to the photoconductor 2 when the head 51 of the writing unit 5 enters.

When the process cartridge 3 is inserted into the apparatus 1A, the writing unit 5 rotates in the direction to face the photoconductor 2 in synchrony with insertion of the process cartridge 3. Hence, when it is opposed to the guide section 3B of the process cartridge 3, the head 51 is moved and positioned under a bias from the elastic member 53 toward the photoconductor 2.

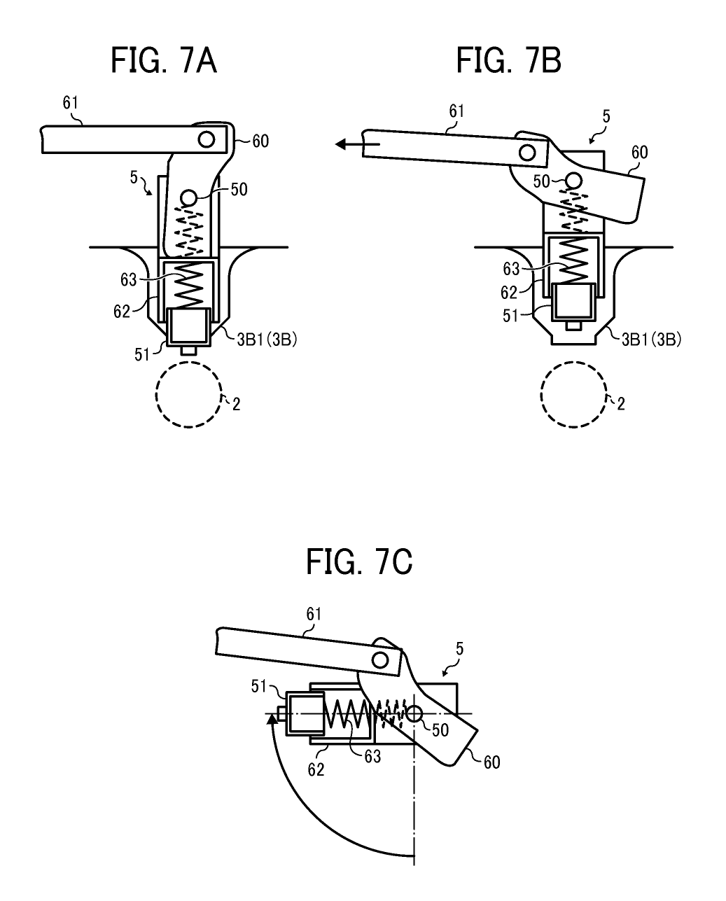

Now, a modification of the evacuation mechanism that separates the writing unit 5 from the photoconductor 2 is described. The evacuation in this case corresponds to an operation in which the writing unit 5 rotates in the direction in which the process cartridge 3 is withdrawn outside in synchrony with the withdrawing of the process cartridge 3 as described with reference to FIGS. 4 and 5. In the modification shown in FIGS. 7A to 7C, the evacuation of the writing unit 5 is executed in synchrony with opening and closing operation of a cover 1B pivotally attached to the apparatus 1A. Although, it is not described with reference to FIGS. 7A to 7C, the writing unit 5 is enabled to rotate in the direction in which the process cartridge 3 is withdrawn as shown in FIG. 3.

Further, as shown in FIGS. 7A-7C, the writing unit 5 includes a cam 60 with a supporting shaft 50 as a rotary fulcrum. One end in an extension direction of a link lever 61 linked to the cover 1B attached to the apparatus 1A is attached to one free end of the cam 60. The writing unit 5 has a head 51 at its tip and a holder 62 vertically movably holding the head 51 up and down as shown there. The head 51 can ordinarily leave the photoconductor 2 receiving traction force from an elastic member 63, such as a compression spring stretched between the supporting shaft 50, etc. The elastic member 63 employed in this modification is different from the elastic member 53 shown in FIG. 6 and keeps the head 51 away from the photoconductor 2 by the traction force.

Whereas the other free end of the cam 60 faces the holder 62. Further, FIG. 7A illustrates an aspect when the cover 1B is closed. When the cover 1B is closed in the drawing, the link lever 61 moves to the right in the drawing. When the link lever 61 moves to the right, the cam 60 swings clockwise in FIG. 7A and presses against and moves the holder 62 down. Hence, since the cam 60 and the holder 62 become an erecting state as shown in the drawing, the head 51 of the writing system 5 is maintained to be opposed to the photoconductor 2.

Further, FIG. 7B illustrates an aspect when the cover 1B is opened. When the cover 1B is opened, the link lever 61 moves to the left in the drawing. When the link lever 61 moves to the left in the drawing, the cam 60 swings counterclockwise in FIG. 7B and deviates from an upper surface of the holder 62. The holder 62 evacuates away from the photoconductor 2 along with the head 51 under the traction force of the elastic member 63. Further, since the writing unit 5 is enabled to rotate in the direction in which the process cartridge 3 is withdrawn as shown in FIG. 3, the writing unit 5 rotates in the direction in which the process cartridge 3 is withdrawn as shown in FIG. 7C when the cam 60 deviates from the upper surface of the holder 62. Hence, the head 51 evacuates to a position distanced from the photoconductor 2.

Hence, according to these embodiments, in accordance with an installation and extraction condition of the process cartridge 3 or an open state of the cover 1B opened and closed when the process cartridge 3 is installed and extracted, the head 51 of the writing unit 5 evacuates to a position distanced from the photoconductor 2. In particular, since the writing unit 5 changes a distance between the photoconductor and the head facing each other using rotary motion instead of moving vertically operation, a space needed for moving vertically can be omitted.

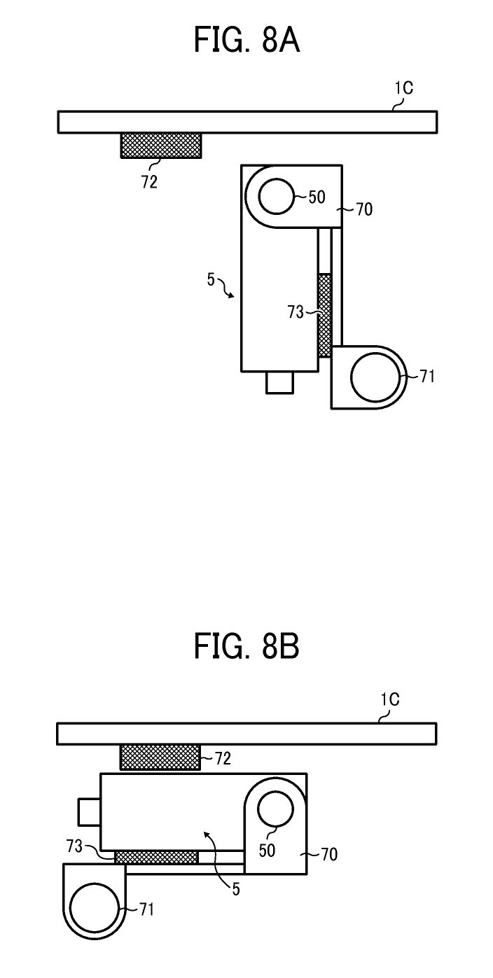

Now, another exemplary evacuation mechanism provided in the writing device 5 is described. FIGS. 8A and 8B collectively illustrate an essential part of a modification of the system shown in FIGS. 5A and 5B. The modification is characterized by a configuration capable of easily in synchrony with an operation of insertion and removal of the process cartridge 3 and that capable of increasing shock resistance of the LED array. Specifically, there is provided a lifter 70 around the supporting shaft 50 as a rotation fulcrum in the writing unit 5 as shown in FIG. 8. A base end of the lifter 70 is attached to the above-described supporting shaft 50, and is rotatable in the direction in which the process cartridge 3 is withdrawn by bias from a biasing device, not shown, as in the configuration as described with reference to FIGS. 5A and 5B. Specifically, at a tip of the lifter 70, a roller 71 capable of facing the cam side 3A formed in the process cartridge 3 is provided. Whereas, a pair of shock absorbers 72 and 73 is located between the lifter 70 and a wall of the writing unit 5, and the lifter 70 and an upper surface section 1C of the apparatus 1A facing the writing unit 5 when rotated in the direction in which the writing unit 5 evacuates from the photoconductor 2.

In the above-described system, an operation of the writing unit 5 similar to that as described with reference to FIG. 5 is executed. However, since the roller 71 in the lifter 70 is opposed to the cam side 3A of the process cartridge 3, sliding resistance or the like is rarely generated, and accordingly rotation of the writing unit 5 can be smooth. Further, when the writing device 5 evacuates from the photoconductor 2 in a direction separating therefrom, the impact generated upon stop of rotation is absorbed by the shock absorbers 72 and 72. Accordingly, a problem, such as damage to the LED, etc., possibly induced by the shock can substantially be avoided.

According to one embodiment of the present invention, the LED array head can be rotated in synchrony with either detaching and attaching operation of a process cartridge or opening operation of an openably closable cover. With this, the risk of soiling or damaging the LED array can be substantially eliminated. As a result, occurrence of defective writing and attendant abnormal images can be substantially prevented.

Numerous additional modifications and variations of the present invention are possible in light of the above teachings. It is therefore to be understood that within the scope of the appended claims, the present invention may be practiced otherwise than as specifically described herein.

What is claimed is:

1. An image forming apparatus comprising:
a detachable latent image bearer;
a casing including a cover opened and closed when the latent image bearer is detached and attached thereto;
an LED array head opposed to the latent image bearer; and
a rotation mechanism to rotate the LED array head in synchrony with either insertion and removal operation of the latent image bearer or opening of the cover.

2. The image forming apparatus as claimed in claim 1, wherein the latent image bearer is housed in a process cartridge along with an image forming device.

3. The image forming apparatus as claimed in claim 2, wherein the LED array head is rotated when the cover is opened and the process cartridge is withdrawn outside the apparatus from a position opposed to the latent image bearer.

4. The image forming apparatus as claimed in claim 2, wherein the process cartridge includes a guide to locate the LED array head at a prescribed position opposed to the latent image bearer when the process cartridge is inserted into the apparatus.

5. The image forming apparatus as claimed in claim 2, wherein the LED array head includes a rocking arm biased in a direction in which the process cartridge is withdrawn outside,
wherein the process cartridge includes a cam side to engage and stop swinging of the rocking arm against bias,
wherein the rocking arm is allowed to swing along the cam side in a direction in which the process cartridge is withdrawn outside in synchrony with withdrawing operation of the process cartridge to evacuate the LED array head from the latent image bearer.

6. The image forming apparatus as claimed in claim 1, further comprising a link lever linked with the cover of the apparatus to cooperate with opening and closing of the cover, the link lever including a cam facing the LED array head, wherein the LED array head is enabled to either contact or separate from the latent image bearer in accordance with movement of the link lever.

7. The image forming apparatus as claimed in claim 1, further comprising a first shock absorber arranged to absorb shock when contacted by the LED array head rotating and evacuating from the latent image bearer.

8. The image forming apparatus as claimed in claim 6, wherein the rocking arm of the LED array head includes an engaged section protruding toward the process cartridge from its free end when located at an evacuated position from the latent image bearer, the engaging section being depressed by the process cartridge when the process cartridge is inserted and located at a prescribed insertion position.

9. The image forming apparatus as claimed in claim 6, wherein the LED array head includes a swingable lifter swingable in a direction in which the process cartridge containing the latent image bearer is withdrawn, the swingable lifter including a roller contacting the cam side formed on the process cartridge.

10. The image forming apparatus as claimed in claim 7, further comprising a second shock absorber arranged between the swingable lifter and the LED array head.

11. A method for detaching or attaching a detachable latent image bearer from or to an image forming apparatus accommodating an LED array head opposed to the latent image bearer, the method comprising the steps of:
opening or closing a cover;
detaching or attaching the latent image bearer from or to the image forming apparatus; and
rotating the LED array head in synchrony with either insertion and removal operation of the latent image bearer or opening of the cover with a rotation mechanism.

12. The method as claimed in claim 11, wherein the latent image bearer is housed in a process cartridge along with an image forming device.

13. The method as claimed in claim 12, wherein the LED array head is rotated when the cover is opened and the process cartridge is withdrawn outside the apparatus from a position opposed to the latent image bearer.

14. The method as claimed in claim 12, wherein the process cartridge includes a guide to locate the LED array head at a prescribed position opposed to the latent image bearer when the process cartridge is inserted into the apparatus.

15. The method as claimed in claim 12, wherein the LED array head includes a rocking arm biased in a direction in which the process cartridge is withdrawn outside,
wherein the process cartridge includes a cam side to engage and stop swinging of the rocking arm against bias,
wherein the rocking arm is allowed to swing along the cam side in a direction in which the process cartridge is withdrawn outside in synchrony with withdrawing operation of the process cartridge to evacuate the LED array head from the latent image bearer.

16. The method as claimed in claim 11, further comprising a link lever linked with the cover of the apparatus to cooperate with opening and closing of the cover, the link lever including a cam facing the LED array head, wherein the LED array head is enabled to either contact or separate from the latent image bearer in accordance with movement of the link lever.

17. The method as claimed in claim 11, further comprising a first shock absorber arranged to absorb shock when contacted by the LED array head rotating and evacuating from the latent image bearer.

18. The method as claimed in claim 11, wherein the rocking arm of the LED array head includes an engaged section protruding toward the process cartridge from its free end when located at an evacuated position from the latent image bearer, the engaging section being depressed by the process cartridge when the process cartridge is inserted and located at a prescribed insertion position.

19. The method as claimed in claim 16, wherein the LED array head includes a swingable lifter swingable in a direction in which the process cartridge containing the latent image bearer is withdrawn, the swingable lifter including a roller contacting the cam side formed on the process cartridge.

20. An image forming apparatus comprising:
a detachable latent image bearer;
a casing including a cover opened and closed when the latent image bearer is detached and attached thereto;
an LED array head opposed to the latent image bearer; and
means for swinging the LED array head in synchrony with either insertion and removal operation of the latent image bearer or opening of the cover.
